(19) United States
(12) Patent Application Publication
(10) Pub. No.: US 2024/0181553 A1
(43) Pub. Date: Jun. 6, 2024

(54) WELDING TORCH WITH WIRE ELECTRODE GUIDE

(71) Applicant: Lincoln Global, Inc., Santa Fe Springs, CA (US)

(72) Inventors: John R. Procario, Strongsville, OH (US); Eric A. Gulliver, Cleveland, OH (US); Matthew A. Albright, Thompson, OH (US); Judah B. Henry, Painesville, OH (US)

(21) Appl. No.: 18/072,812

(22) Filed: Dec. 1, 2022

(51) Int. Cl. B23K 9/28; B23K 9/12; B23K 9/32

(52) U.S. Cl. CPC B23K 9/282; B23K 9/122; B23K 9/324

(57) ABSTRACT

A welding torch includes a contact tip and a wire electrode guide extending distal of the contact tip. The wire electrode guide includes a metallic outer sheath and a plurality of ring-shaped electrical insulators stacked axially within the metallic outer sheath so as to form a central wire electrode receiving bore through the plurality of ring-shaped electrical insulators.

### BACKGROUND OF THE INVENTION

### Field of the Invention

The present invention relates to arc welding, and in particular to torches for submerged arc welding (SAW).

### Description of Related Art

Various welding technologies utilize welding wires that serve as a source of metal. For example, in metal arc welding, an electric arc is created when a voltage is applied between a consumable wire welding electrode, which serves as one electrode that advances towards a workpiece, and the workpiece, which serves as another electrode. The arc melts a tip of the metal wire, thereby producing droplets of the molten metal wire that deposit onto the workpiece to form a weldment or weld bead.

Submerged arc welding is a type of welding where the arc between the wire electrode and the workpiece is completely submerged in a covering of granular fusible flux. The flux protects the molten weld puddle from atmospheric contamination. Submerged arc welding systems, like other types of welding systems, may include a welding power supply, a wire feed control and drive assembly and a welding torch. In addition, submerged arc welding systems also include a flux system. The flux system holds and delivers the flux to the weld joint during welding. Submerged arc welding can provide highly economic solutions for some applications. The high deposition rates attained with SAW are chiefly responsible for the economies achieved with the process.

Deposition rates for SAW can be improved by utilizing a long stick-out (LSO) or extended stick-out (ESO) of the welding wire, due to the current flow through the wire stick-out heating the distal portion of the welding wire. However, the heated LSO wire is prone to moving out of alignment and wander in a welding groove, particularly in deep narrow grooves between thick workpieces. It would be desirable to perform LSO SAW in deep and/or groove welds while maintaining proper alignment of the heated wire electrode along the weld path within the groove.

### BRIEF SUMMARY OF THE INVENTION

The following summary presents a simplified summary in order to provide a basic understanding of some aspects of the devices, systems and/or methods discussed herein. This summary is not an extensive overview of the devices, systems and/or methods discussed herein. It is not intended to identify critical elements or to delineate the scope of such devices, systems and/or methods. Its sole purpose is to present some concepts in a simplified form as a prelude to the more detailed description that is presented later.

In accordance with one aspect of the present invention, provided is a welding torch. The welding torch includes a contact tip and a wire electrode guide extending distal of the contact tip. The wire electrode guide includes a metallic outer sheath and a plurality of ring-shaped electrical insulators stacked axially within the metallic outer sheath so as to form a central wire electrode receiving bore through the plurality of ring-shaped electrical insulators.

In accordance with another aspect of the present invention, provided is a welding torch. The welding torch includes a contact tip and a wire electrode guide extending distal of the contact tip. The wire electrode guide includes a metallic outer sheath and a plurality of ceramic electrical insulators stacked axially within the metallic outer sheath. Each ceramic electrical insulator has a central opening such that the plurality of ceramic electrical insulators stacked axially within the metallic outer sheath form a central wire electrode receiving bore for a wire electrode energized by the contact tip.

In accordance with another aspect of the present invention, provided is a welding torch. The welding torch includes a contact tip and a wire electrode guide mounted beneath the contact tip to receive a wire electrode energized by the contact tip. An air gap exists between the contact tip and the wire electrode guide that exposes the energized wire electrode to ambient air. The wire electrode guide includes a metallic outer sheath and a plurality of ceramic ring-shaped electrical insulators stacked axially within the metallic outer sheath so as to form a central wire electrode receiving bore through the plurality of ceramic ring-shaped electrical insulators. The plurality of ceramic ring-shaped electrical insulators electrically insulate the wire electrode from the metallic outer sheath.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 schematically shows a submerged arc welding system;

FIG. 2 shows a torch for long stick-out submerged arc welding;

FIG. 3A shows portions of a torch for long stick-out submerged arc welding;

FIG. 3B shows a torch for long stick-out submerged arc welding;

FIG. 4 schematically shows a wire electrode guide for long stick-out submerged arc welding;

FIG. 5 shows a wire electrode guide for long stick-out submerged arc welding; and

FIG. 6 schematically shows a wire electrode guide for long stick-out submerged arc welding.

### DETAILED DESCRIPTION OF THE INVENTION

The present invention relates to torches for submerged arc welding (SAW). The present invention will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the understanding of the drawings. In the following description, for purposes of explanation, numerous specific details are set forth in order to provide a thorough understanding of the present invention. It may be evident, however, that the present invention can be practiced without these specific details. Additionally, other embodiments of the invention are possible and the invention is capable of being practiced and carried out in ways other than as described. The terminology and phraseology used in describing the invention is employed for the purpose of promoting an understanding of the invention and should not be taken as limiting.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. Any disjunctive word or phrase presenting two or more alternative terms, whether in the description of embodiments, claims, or drawings, should be understood to contemplate the possibilities of including one of the terms, either of the terms, or both terms. For example, the phrase “A or B” should be understood to include the possibilities of “A” or “B” or “A and B.”

While embodiments of the present invention described herein are discussed in the context of a submerged arc welding (SAW) system, other embodiments of the invention are not limited thereto. For example, embodiments can be utilized in gas metal arc welding (GMAW), flux-cored arc welding (FCAW), metal-cored arc welding (MCAW) as well as other similar types of welding operations. Further, embodiments of the present invention can be used in manual, semi-automatic and robotic welding operations. Embodiments of the present invention can also be used in metal deposition operations that are similar to welding, such as additive manufacturing, hardfacing, and cladding. As used herein, the term “welding” is intended to encompass all of these technologies as they all involve material deposition to either join or build up a workpiece. Therefore, in the interests of efficiency, the term “welding” is used below in the description of exemplary embodiments, but is intended to include all of these material deposition operations, whether or not joining of multiple workpieces occurs.

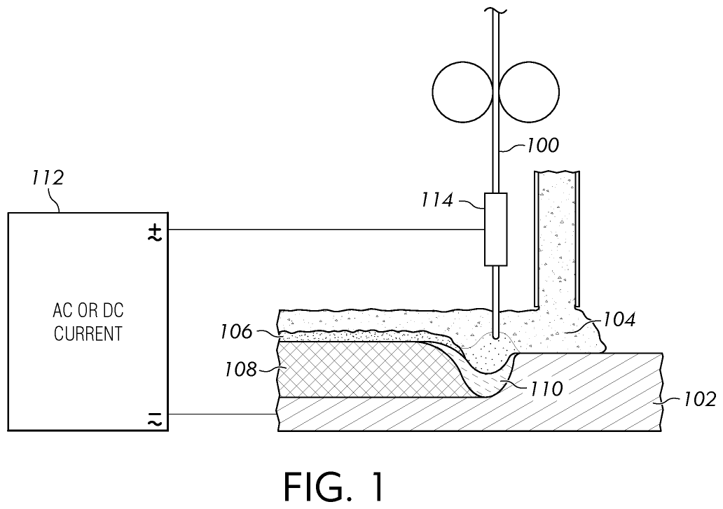

The submerged arc welding process (SAW), unlike the other fluxed processes, uses two consumables, the wire and the flux, that may be supplied separately. FIG. 1 schematically illustrates the submerged arc welding process. Heat for the submerged arc welding process is derived from an arc between a bare metal wire welding electrode 100 and a workpiece 102. The arc is shielded by a blanket of granular fusible material called flux 104 which is placed over the joint area ahead of the arc. Filler metal is obtained primarily from the electrode wire 100 which is continuously fed through the blanket of flux 104 into the arc and pool of molten flux. Additional filler may be obtained by adding cold wire to the weld pool granular flux or from metal powder contained in the flux.

The distinguishing feature of SAW is the flux 104, which covers the weld area and prevents arc radiation, sparks, spatter and fumes from escaping. The flux 104 allows for achieving the high deposition rates and high quality weld deposit characteristics. In addition to shielding the arc from view, the flux 104 provides a slag 106 which protects the weld metal 108 as it cools, deoxidizes and refines the weld metal, insulates the weld to reduce the cooling rate and helps shape the weld contour.

During welding, the heat of the arc melts some of the flux 104 along with the tip of the electrode 100 as illustrated in FIG. 1. The tip of the electrode 100 and the welding zone are always surrounded and shielded by molten flux covered by a layer of unfused flux. The electrode 100 is held a short distance above the workpiece 102 with the arc between the electrode and the workpiece. As the electrode 100 progresses along the joint, the lighter molten flux rises above the molten metal 110 in the form of a slag 106. The weld metal 108 which has a higher melting (freezing) point, solidifies while the slag 106 above it is still molten. The slag 106 then freezes over the newly solidified weld metal 108, continuing to protect the metal from contamination while it is very hot and would react with atmospheric oxygen and nitrogen. After cooling and removing any unfused flux for reuse, the solidified slag 106 may be easily removed from the weld.

High currents can be used in submerged arc welding and extremely high heat can be generated. Because the current is applied to the electrode 100 a short distance above its tip, relatively high amperages can be used on small diameter electrodes. This results in extremely high current densities on relatively small cross sections of electrode (e.g., a current density six to ten times that carried on stick electrodes). Because of the high current density, the melt off rate is much higher for a given electrode diameter than with stick-electrode welding. The melt-off rate is affected by the electrode material, the flux, type of current, polarity, and length of wire beyond the point of electrical contact in the welding gun or torch head.

FIG. 1 schematically shows an example welding power supply 112 for supplying electrical energy to the wire electrode 100 to generate the welding arc. Electrical energy is conducted to the wire electrode 100 via a welding torch 114 having a contact tip electrically connected to the electrode. Submerged arc welding may be done with either DC or AC power. Direct current gives better control of bead shape, penetration, and welding speed, and arc starting is easier with it. Bead shape is usually best with DC electrode positive (reverse polarity), which also provides maximum penetration. Highest deposition rates and minimum penetration are obtained with DC electrode negative. Alternating current minimizes arc blow and can provide penetration between that of DCEP and DCEN.

The insulating blanket of flux 104 above the arc prevents rapid escape of heat and concentrates it in the welding zone. Not only are the electrode 100 and base metal 102 melted rapidly, but the fusion is deep into the base metal. The deep penetration allows the use of small welding grooves, thus minimizing the amount of filler metal per foot of joint and permitting fast welding speeds. Fast welding, in turn, minimizes the total heat input into the assembly and, thus minimizes problems of heat distortion. Even relatively thick joints can be welded in one pass by submerged arc welding.

Welds 108 made under the protective layer of flux 104 have good ductility and impact resistance and uniformity in bead appearance. Mechanical properties at least equal to those of the base metal 102 are consistently obtained. In single-pass welds, the fused base material 102 is large compared to the amount of filler metal used. Thus, in such welds the base metal may greatly influence the chemical and mechanical properties of the weld 108. For this reason, it is sometimes unnecessary to use electrodes 100 of the same (or overmatching) composition as the base metal 102 for welding many of the low-alloy steels. However, the chemical composition and properties of multipass welds are less affected by the base metal and depend to a greater extent on the composition of the electrode 100, the activity of the flux 104, and the welding conditions.

Through regulation of current, voltage, and torch travel speed, an operator can exercise close control over penetration to provide any depth ranging from deep and narrow with high-crown reinforcement, to wide, nearly flat beads with shallow penetration. Beads with deep penetration may contain on the order of 70% melted base metal, while shallow beads may contain as little as 10% base metal. In some instances, the deep-penetration properties of submerged arc can be used to eliminate or reduce the expense of edge preparation.

The flux 104 serves several functions in submerged arc welding. These include covering the molten weld metal 110 to protect it from the atmosphere and acting as a slag 106 which refines the molten deposit by scavenging oxides and other non-metallic inclusions. Metallic additions to the flux can add to the alloy content of the weld metal deposit 108 and deoxidize it.

With proper selection of equipment, submerged arc is widely applicable to the welding requirements of industry. It can be used with all types of joints, and permits welding a full range of carbon and low alloy steels, from 16-gage sheet to the thickest plate. It is also applicable to some high-alloy, heat-treated, and stainless steels, and is a favored process for rebuilding and hard surfacing. Any degree of mechanization can be used—from the hand-held semi-automatic gun to boom or track-carried and fixture held multiple welding heads.

The high quality of submerged arc welds, the high deposition rates, the deep penetration, the adaptability of the process to full mechanization, and the comfort characteristics (no glare, sparks, spatter, smoke, or excessive heat radiation) make it a preferred process in steel fabrication. It is used extensively in ship and barge building, railroad car building, pipe manufacture, and in fabricating structural beams, girders, and columns where long welds are required. Automatic submerged arc installations are also key features of the welding areas of plants turning out mass-produced assemblies joined with repetitive short welds.

Other factors than deposition rates enter into the lowering of welding costs. Continuous electrode feed from coils, ranging in weight from 60 to over 2,000 pounds, contributes to a high operating factor. Where the deep-penetration characteristics of the process permit the elimination or reduction of joint preparation, expense is reduced. After the weld has been run, cleaning costs are minimized, because of the elimination of spatter by the protective flux.

When submerged arc welding is performed properly, the weld beads are smooth and uniform, so that grinding or machining are rarely required. Since the rapid heat input of the process minimizes distortion, the costs for straightening finished assemblies are reduced, especially if a carefully planned welding sequence has been followed. Sub merged-arc welding, in fact, often allows the pre-machining of parts, further adding to fabrication cost savings.

Because of these and other advantages provided by SAW, there is a desire and need to further improve various aspects of SAW, including even higher productivity and weld quality. For example, as one of the technical advantages of SAW derives from preheating the consumable electrode, there is a desire and need to further improve the preheating arrangement through improved electrode assembly or torch design.

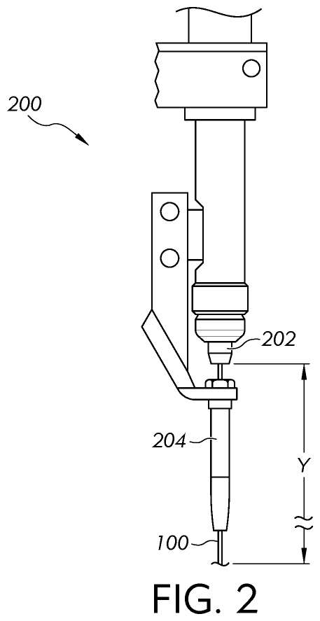

FIG. 2 illustrates a torch or electrode assembly 200 defining an electrical stick-out. An electrical stick-out or electrical electrode extension refers to the distance Y between the tip of the contact tip 202 and the end of the wire welding electrode 100. The stick-out portion of the wire welding electrode 100 is preheated by Joule heating due to the welding current flowing through the wire and the electrical resistance of the wire. If the electrode extension is not sufficient, the electrode wire will not be preheated enough. One the other hand, an increase of the length of the electrical stick-out increases the electrical resistance of the circuit, which in turn increases the heating and hence the temperature of the tip of the electrode, leading to increased melting and deposition rate. The stick-out length in turn controls the dimensions of the weld bead since the length of the filler wire extension affects the burn-off rate. Further, electrode extension exerts an influence on penetration through its effect on the welding current. As the extension length is increased, the preheating of the wire increases and the current is reduced. The current reduction in turn decreases the amount of penetration into the work piece.

Stick-out distance may typically vary from ⅛ to ½ inches for traditional welding processes and ¾ to 1.5 inches for submerged arc welding (SAW). To further improve upon SAW technology, a long stick-out (LSO) or extended stick-out (ESO) may be employed. Long stick-out SAW refers to SAW processes in which the length of the wire that sticks out (“stick-out length”) of the electrode contact tip, or the contact-to-work distance (CTWD), is increased relative to conventional SAW processes, e.g., longer than about 25 mm. The longer stick-out length allows for a greater length of the electrode to be preheated prior to melting at the electrode tip. The preheating allows for melt-off rate to increase as a result, as it is easier to melt a preheated electrode wire for a given current density. The LSO SAW process can provide significant improvement in productivity and can provide up to 100% increase in submerged arc welding deposition rates over traditional SAW processes. The LSO SAW process can reduce or eliminate arc striking problems by allowing complete tailoring of the arc start characteristics. The LSO SAW can also provide improved control over the input of energy into the weld, lower heat input (less distortion), and a flux/wire ratio reduction. Another benefit of LSO SAW is that higher deposition and productivity can be achieved at lower heat inputs.

As discussed above, increased stick-out length can provide certain advantages, such as higher deposition rate without increasing energy consumption. However, for stick-out length exceeding, e.g., 25 mm, various problems may arise. For example, the heated wire can move out of alignment and wander in the welding groove as the stick-out distance increases. This can pose a problem especially in welding deep and narrow grooves that may be used to minimize time and cost of joining thick workpiece sections, as LSO welding electrode assemblies can be too bulky to reach the bottom of the groove. To address this and other challenges, in addition to the contact tip 202, the SAW welding torch 200 can employ an extension portion to serve as a wire electrode guide 204 (see FIG. 2). The extension portion or wire electrode guide 204 provides, among other things, electrical and thermal insulation as well as mechanical rigidity to the heated wire electrode 100. FIG. 2 illustrates an example electrode assembly configured for long stick-out submerged arc welding, including wire electrode guide 204 or extension portion. As illustrated, the wire electrode guide 204 extends distal of the contact tip 202. The wire electrode guide 204 is located between the contact tip and the workpiece (not shown). In certain embodiments, as can be seen in FIG. 2, an air gap exists between the contact tip 202 and the wire electrode guide 204. The air gap exposes the wire electrode 100 extending through the contact tip 202 and the wire electrode guide 204 to ambient air. In other embodiments, the contact tip 202 and wire electrode guide 204 can be directly adjacent to one another without an air gap existing between them, so that the wire electrode 100 is not exposed to ambient air.

Conventional electrode assemblies may not be suitable for some applications, e.g., for filling narrow and deep grooves such as a triangular or U-shaped groove having a depth exceeding 4 inches and having an angle of an apex that is 16 degrees or less. Among other shortcomings, the inventors have discovered that existing designs of the electrode assemblies may be insufficient with respect to one or more of: optimized vertical and lateral dimensions, thermal and electrical insulation, arc instability caused by magnetic materials and compact flux delivery. Various embodiments of the electrode assembly for submerged arc welding described herein address these and other needs.

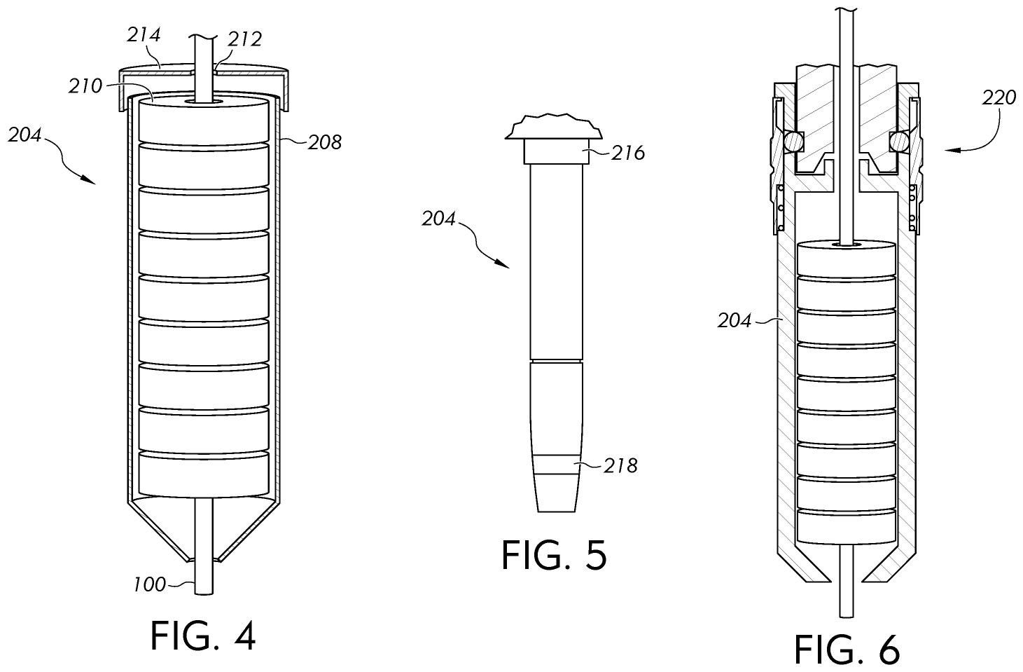

Disclosed herein are electrode assemblies for improved LSO SAW and methods of using the same. The inventors have found that, by optimizing various aspects of the electrically insulated extended stick-out portion of the electrode, significant further improvements in the LSO SAW can be achieved. FIGS. 2-4 illustrate portions of a SAW torch configured for long stick-out submerged arc welding, according to various embodiments. FIG. 4 illustrates the wire electrode guide 204 of the torch 200. The electrode assembly according to various embodiments comprises a contact tip portion 202 and an extension portion or wire electrode guide 204 arranged serially and configured to feed a consumable electrode therethrough. In the illustrated example, the serially arranged contact tip 202 the guide 204 are physically separated and exposes the consumable electrode 100 therebetween. In other arrangements, the contact tip 202 and guide 204 may contact each other. During welding, the contact tip 202 is disposed to be upstream to an arcing tip of the consumable electrode 100 and the wire electrode guide 204 is disposed to be adjacent to the arcing tip of the electrode. The contact tip 202 is in electrical contact with the consumable electrode 100 to provide power thereto. The consumable electrode 100 is fed through the contact tip 202 and exits the contact tip. The consumable electrode 100 is subsequently fed through the wire electrode guide 204. The guide 204 is configured to electrically insulate the consumable electrode 100 from a workpiece (e.g., from the sidewalls of the workpiece) via an insulating material, e.g., a ceramic material, surrounding the consumable electrode. The insulating material is discussed further below with reference to FIG. 4. The consumable welding electrode 100 is preheated in the insulated extension portion or wire electrode guide 204 by Joule heating, prior to being melted at the arcing tip of the consumable electrode. The extent of preheating is a function of distance/resistance between the contact point of the welding circuit with the wire electrode 100 at the contact tip 202 and the arcing point of the wire with the workpiece. The wire electrode guide 204 provides physical support and protection for the preheated wire to ensure proper placement of the deposited metal during SAW.

In various embodiments, the guide 204 is configured to electrically insulate the consumable electrode from a workpiece and has a shape, length and a lateral dimension such that the guide is configured to be capable of being inserted into narrow grooves between workpieces. The insulating material surrounding the consumable electrode 100 inside the guide 204 allows the lateral dimension to be significantly reduced. As a result, the guide 204 is configured to not contact a sidewall of a narrow groove such as a triangular or U-shaped trench having a depth exceeding 4 inches, 5 inches, 6 inches, 7 inches, or a value in a range defined by any of these values, and having an angle of an apex that is less than 16 degrees, 12 degrees, 10 degrees, 8 degrees, 6 degrees, or a value in a range defined by any of these values, while the tip of the consumable electrode 100 contacts the apex. It will be appreciated that shallower the groove, the narrower the apex angle. For example, the relationship may follow an example dependence such as that shown in TABLE 1, without limitation. It will be appreciated that the grooves or trenches may not have a triangular shape in cross-section. Instead, some grooves may have, e.g., a rectangular or tapered rectangular shape. In these geometries, the “apex” angle or the acceptance angle can be defined by an arctan of a width over depth of the trench.

TABLE 1

| Groove Depth | Apex Angle | |
|---|---|---|
| >2 in. | <8 | deg. |
| >3 in. | <10 | deg. |
| >4 in. | <12 | deg. |

In various embodiments, the wire electrode guide 204 is configured to electrically insulate the consumable electrode 100 from a workpiece during welding while having an outer surface formed of a substantially non-magnetic material surrounding the consumable electrode. The outer envelope or outer sheath of the guide 204 can be metallic, such as formed from a non-magnetic steel, e.g., a stainless steel, or another non-magnetic metal. The inventors have discovered that the non-magnetic envelope advantageously improves the magnetic field around the electrode and reduces the resulting arc instability and welding defects. The non-magnetic envelope also reduces any instability of the welding parameters that may be caused by magnetization of the guide 204 over time.

In various embodiments, the wire electrode guide 204 is configured to electrically insulate the consumable electrode 100 from a workpiece and has a shape, length and a lateral dimension such that a contact-to-work distance (CTWD) during welding exceeds 25 mm, 100 mm, 125 mm, 150 mm, 175 mm, or a length in a range defined by any of these values, e.g., 150-160 mm. The longer CTWD as compared to conventional SAW welding processes substantially improves the deposition rate for a given current density, due to the longer Joule-heated region provided the extension portion.

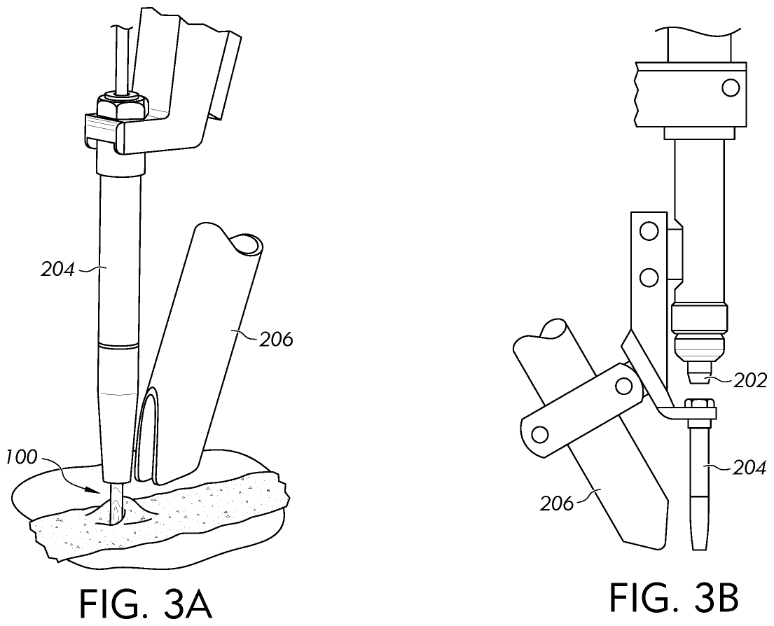

In various embodiments, as shown in FIGS. 3A and 3B, a flux delivery or discharge nozzle 206 can be attached to a bracket for the wire electrode guide 204. The flux delivery nozzle 206 is located adjacent to the wire electrode guide 204 and discharges flux to blanket the weld zone during SAW. Advantageously, the flux delivery nozzle 206 can have a narrow cross-section, similar to the diameter of the guide 204, to allow both to be inserted into narrow grooves during welding.

According to various embodiments, the LSO SAW electrode assemblies having an insulated extension portion are configured to achieve a significantly higher deposition rate as compared to conventional SAW electrode assemblies for the same current. Example experimental deposition rates that can be achieved for one example configuration in which the CTWD was 5″ and the electrode diameter was 5/32″ is as follows: the deposition rate per current can exceed 0.05 lbs./hr./A, 0.06 lbs./hr./A, 0.07 lbs./hr./A, 0.08 lbs./hr./A, or a value in range defined by any of these values during welding; a deposition rate exceeding 35 lbs./hr. may be achieved at less than about 900 A, 850 A, 800 A, 750 A, 700 A, or in a range defined by any of these values, e.g., at about 700 A-750 A. A similar deposition rate is only projected to be achieved at a current exceeding about 900 A using conventional SAW electrode assemblies. Advantageously, the improvement in deposition rate over conventional SAW electrodes increases at higher current, as Joule heating (I²R) varies as a square of current. That is, the relative improvement in deposition rate is projected to increase with increasing current.

As a result of the longer CTWD, a higher fraction of the voltage between the contact tip and the workpiece drops across the LSO wire electrode. The LSO wire electrode according to embodiments is configured to drop at least 5%, 10%, 15%, 20% or a value in a range defined by any of these values, of a total voltage drop across the contact-to-work distance (CTWD). The remaining voltage drop occurs across the arc. The electrode assembly according to embodiments is configured to drop at fraction exceeding 1/30, 1/15, 1/10, 1/7, ⅕, or a value in a range defined by any of these values, of a total voltage drop cross a contact-to-work distance (CTWD). For example, of a total example voltage drop of 30V, about 4V drops across the LSO wire electrode, while the rest (about 26V) drops across the arc length. In contrast, for a conventional SAW electrode assembly, of the same total voltage drop of 30V, only about 1V drops across the electrode, while the rest (about 29V) drops across the arc length. As result, compared to conventional SAW electrode configuration, a longer length of the welding electrode is heated to a higher temperature, which increases the deposition rate.

An added benefit offered by the electrode assembly according to embodiments is the decreased flux-to-wire consumption ratio. The electrode assembly according to embodiments is configured to heat the consumable wire electrode within the extension portion to a temperature up to 600° C., 700° C., 800° C., 900° C., or a temperature in a range defined by any of these values.

FIG. 4 shows an example embodiment of the wire electrode guide 204. The wire electrode guide 204 has an outer sheath 208. In certain embodiments, the outer sheath 208 is metallic, such as made from stainless steel or another metal. The outer sheath 208 can be made from a non-magnetic material, such as a non-magnetic metal. In other embodiments, the outer sheath 208 can be nonmetallic, such as made from a high temperature polymer.

Within the metallic outer sheath 208 are a plurality of electrical insulators 210 stacked axially within the metallic outer sheath. Each of the electrical insulators 210 has a central opening 212 for receiving the wire electrode 100. The stack of electrical insulators 210, in particular their axially-aligned central openings 212, form a central wire electrode receiving bore through the plurality of insulators for the wire electrode 100. The energized wire electrode 100 (energized by the contact tip in the torch) is fed through the central wire electrode receiving bore formed by the stack of electrical insulators 210. The electrical insulators 210 electrically insulate the energized wire electrode 100 from the outer sheath 208 and the adjacent workpiece(s) to prevent a short circuit. Should the wire electrode guide 204 contact a workpiece, the insulators 210 will prevent the wire electrode 100 from shorting to the workpiece unintentionally.

The inner perimeter or surface of the metallic outer sheath 208 and the outer perimeter surface of the electrical insulators 210 can closely match (e.g., both can have a cylindrical shape or another shape such as a polygonal shape). In the example embodiment shown in FIG. 4, the plurality of electrical insulators 210 are ring-shaped or have an annular shape. The upper or proximal portion of the sheath 208 can be generally cylindrical. The bottom or distal portion of the sheath 208 can be tapered to retain the insulators 210 within the sheath; however, various methods for retaining the insulators within the sheath will be apparent to one of ordinary skill in the art.

The wire electrode guide 204 can include a removable cap 214 (e.g., a threaded cap) that provides access to the insulators 210. It is possible that one or more insulators 210 could be damaged (e.g., cracked or broken) during use. For example, the wire electrode guide 204 can be inserted into a weld groove between workpieces and may unintentionally strike a workpiece during welding setup or during actual welding. The impact with a workpiece may damage one or more of the plurality of electrical insulators 210 since they can be brittle. The removable cap 214 allows the wire electrode guide 204 to be repaired and the insulators 210 to be replaced as needed. In certain embodiments, the inner circumference of the sheath 208 and the outer circumference of the insulators 210 can closely match so that there is little to no radial movement of the insulators within the sheath. A clearance can be provided between the outer circumference of each of the insulators 210 and an inner wall of the sheath 208 to permit relative radial movement between adjacent insulators within the sheath. Such a clearance could allow axially adjacent insulators 210 to slide radially over one another slightly (e.g., during an impact of the wire electrode guide 204 with a workpiece) within the sheath 208 while maintaining the central wire electrode receiving bore. In certain embodiments, the upper and/or lower surfaces of the insulators 210 can have projections or nubs that create small spaces or air gaps between adjacent insulators (e.g., adjacent insulators will be spaced slightly apart from each other). The stack of electrical insulators 210 provides some flexibility to the wire electrode guide 204. If the guide 204 should strike a workpiece, the insulators 210 can shift within the metallic sheath 208 and may not crack. However, if one or more insulators 210 do crack, they can be easily replaced. Compared to a single unitary ceramic sleeve, the stack of insulators 210 provides a more durable and less expensive insulating wire guide.

The insulators 210 can have the shape of a washer or O-ring with a short height and relatively wider diameter, or they can be doughnut shaped with a taller height as compared to a washer or O-ring. The insulators 210 can be made from a ceramic material or other appropriate insulating materials. For example, the insulators 210 can be formed of a material selected from the group consisting of silicon nitride, magnesia-stabilized zirconia, yttria-stabilized zirconia, silicon carbide, magnesium oxide, alumina or a zirconia-toughened alumina. Ceramic insulators can be manufactured using various methods such as powder pressing, cold isostatic pressing, hot pressing, injection molding and slip casting.

FIG. 5 shows the wire electrode guide 204 attached to a SAW torch at the proximal end of the guide. Various attachment mechanisms can be used to attach the wire electrode guide 204 to the torch, such as via a threaded connection on the guide. In certain embodiments, the wire electrode guide 204 or the torch can include a magnet 216 that attaches the wire electrode guide to the welding torch. The magnet 216 can act as a crash box that allows the guide 204 to easily separate from the torch without damaging the ceramic insulators should the guide strike a workpiece. Other forms of ready breakaway could be provided between the guide 204 and the torch to allow the guide to easily separate from the torch without damaging the ceramic insulators should the guide strike a workpiece, as would be appreciated by one of ordinary skill in the art.

The wire electrode guide 204 can include a sensor 218 for sensing contact or impending contact between the guide and a workpiece. Examples of such sensors include touch sensors, accelerometers, vibration sensors, etc. A touch sensor can provide a signal to a torch motion controller to inform the controller that the torch has or is about to contact the workpiece. A touch sensor can be particularly useful during welding setup to define the limits of the weld path or weld groove. An accelerometer or vibration sensor could be used to sense torch vibrations due to broken insulators 210 within the guide 204. The sensor 218 could provide a signal to the welding power supply or another device within the SAW system in order to generate an alarm or alert to the operator to inspect and/or repair the guide 204. Alternatively or additionally, the insulators 210 could include isolated electrical continuity circuits incorporated into each separate insulator. Breaking a circuit would indicate that the insulator is damaged, and the welding power supply or another device within the SAW system could inform the operator which specific insulator requires replacement. The torch or wire electrode guide 204 can further include stuck wire detection to inform the torch motion controller and/or the welding power supply that the wire electrode is stuck to the weld metal, so that remedial action can be taken to unstick the frozen wire.

FIG. 6 shows a quick disconnect that can be used to attach the wire electrode guide 204 to the torch. One example quick disconnect is a captive ball quick disconnect, similar to those used on pneumatic systems. In FIG. 6, the female quick disconnect 220 can be attached to the torch to allow the guide 204 to be readily removed therefrom.

Submerged arc welding systems typically do not utilize a shielding gas. However, the systems discussed above (e.g., see FIG. 1) could include a shielding gas if desired. Shielding gas could be used to control the amount of oxygen in the weld metal and to prevent the heated LSO wire electrode from oxidizing. The shielding gas could be discharged from the torch upstream of the wire electrode guide and above or proximal of the air gap between the contact tip and the wire electrode guide.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A welding torch, comprising:
a contact tip; and
a wire electrode guide extending distal of the contact tip, wherein the wire electrode guide comprises:
a metallic outer sheath; and
a plurality of ring-shaped electrical insulators stacked axially within the metallic outer sheath so as to form a central wire electrode receiving bore through the plurality of ring-shaped electrical insulators.

2. The welding torch of claim 1, wherein an air gap exists between the contact tip and the wire electrode guide that exposes a wire electrode extending through the contact tip and the wire electrode guide to ambient air.

3. The welding torch of claim 1, wherein the ring-shaped electrical insulators are formed from a ceramic material.

4. The welding torch of claim 1, further comprising a flux delivery nozzle located adjacent to the wire electrode guide.

5. The welding torch of claim 1, wherein the ring-shaped electrical insulators electrically insulate a wire electrode extending through the contact tip and the wire electrode guide from the metallic outer sheath.

6. The welding torch of claim 1, wherein the metallic outer sheath comprises stainless steel.

7. The welding torch of claim 1, wherein a clearance between an outer circumference of each of the ring-shaped electrical insulators and an inner wall of the metallic outer sheath permits relative radial movement between adjacent ring-shaped electrical insulators within the metallic outer sheath.

8. The welding torch of claim 1, further comprising a captive ball quick disconnect that attaches the wire electrode guide to the welding torch.

9. The welding torch of claim 1, further comprising a magnet that attaches the wire electrode guide to the welding torch.

10. The welding torch of claim 1, further comprising a touch sensor configured to determine contact between the metallic outer sheath and a workpiece.

11. A welding torch, comprising:
a contact tip; and
a wire electrode guide extending distal of the contact tip, wherein the wire electrode guide comprises:
a metallic outer sheath; and
a plurality of ceramic electrical insulators stacked axially within the metallic outer sheath, wherein each ceramic electrical insulator has a central opening such that the plurality of ceramic electrical insulators stacked axially within the metallic outer sheath form a central wire electrode receiving bore for a wire electrode energized by the contact tip.

12. The welding torch of claim 11, wherein each ceramic electrical insulator has an annular shape.

13. The welding torch of claim 12, wherein a clearance between an outer circumference of each of the ceramic electrical insulators and an inner wall of the metallic outer sheath permits relative radial movement between adjacent ceramic electrical insulators within the metallic outer sheath.

14. The welding torch of claim 11, wherein an air gap exists between the contact tip and the wire electrode guide that exposes the wire electrode extending through the contact tip and the wire electrode guide to ambient air.

15. The welding torch of claim 11, further comprising a flux delivery nozzle located adjacent to the wire electrode guide.

16. The welding torch of claim 11, wherein the ceramic electrical insulators electrically insulate the wire electrode extending through the contact tip and the wire electrode guide from the metallic outer sheath.

17. The welding torch of claim 11, wherein the metallic outer sheath comprises stainless steel.

18. The welding torch of claim 11, further comprising a captive ball quick disconnect that attaches the wire electrode guide to the welding torch.

19. The welding torch of claim 11, further comprising a magnet that attaches the wire electrode guide to the welding torch.

20. The welding torch of claim 11, further comprising a touch sensor configured to determine contact between the metallic outer sheath and a workpiece.

21. A welding torch, comprising:
a contact tip; and
a wire electrode guide mounted beneath the contact tip to receive a wire electrode energized by the contact tip, wherein an air gap exists between the contact tip and the wire electrode guide that exposes the energized wire electrode to ambient air, wherein the wire electrode guide comprises:
a metallic outer sheath; and
a plurality of ceramic ring-shaped electrical insulators stacked axially within the metallic outer sheath so as to form a central wire electrode receiving bore through the plurality of ceramic ring-shaped electrical insulators, wherein the plurality of ceramic ring-shaped electrical insulators electrically insulate the wire electrode from the metallic outer sheath.

22. The welding torch of claim 21, further comprising a flux delivery nozzle located adjacent to the wire electrode guide.

23. The welding torch of claim 21, further comprising a captive ball quick disconnect that attaches the wire electrode guide to the welding torch.

24. The welding torch of claim 21, further comprising a magnet that attaches the wire electrode guide to the welding torch.

25. The welding torch of claim 21, further comprising a touch sensor configured to determine contact between the metallic outer sheath and a workpiece.
